(19) United States
(12) Patent Application Publication
(10) Pub. No.: US 2014/0354083 A1
(43) Pub. Date: Dec. 4, 2014

(54) SWITCH

(71) Applicant: Edge-Core Networks Corporation, Hsinchu (TW)

(72) Inventor: Tsung-Han LI, Taichung City (TW)

(73) Assignee: Edge-Core Networks Corporation, Hsinchu (TW)

(21) Appl. No.: 14/293,569

(22) Filed: Jun. 2, 2014

Related U.S. Application Data
(60) Provisional application No. 61/830,244, filed on Jun. 3, 2013.

(30) Foreign Application Priority Data
May 28, 2014 (TW) 103209342

(51) Int. Cl. H01H 9/54

(52) U.S. Cl. CPC H01H 9/54
USPC 307/143

(57) ABSTRACT

A switch is provided. The switch includes a control chip and a trigger device. The trigger device is coupled to a first pin of the control chip. When a user uses the trigger to generate a first control signal, and the control chip detects the first control signal via the first pin, the control chip switches the operating mode of the switch to a managed mode from an unmanaged mode according to the first control signal.

### CROSS REFERENCE TO RELATED APPLICATIONS

This application claims the benefit of U.S. Provisional Application No. 61/830,244 filed on Jun. 3, 2013, the entirety of which is incorporated by reference herein.

This Application claims priority of Taiwan Patent Application No. 103209342, filed on May 28, 2014, the entirety of which is incorporated by reference herein.

### BACKGROUND OF THE INVENTION

1. Field of the Invention

The present invention relates to a switch, and more particularly to a switch with an operating-mode switching mechanism.

2. Description of the Related Art

Conventional unmanaged switches are provided for common consumers and are not equipped with a troubleshooting function. Compared to unmanaged switches, managed switches provide specific interfaces and instructions allowing a person skilled in the art to troubleshoot problems, but common consumers may not benefit from the troubleshooting function because they have no idea to access specific interfaces and instructions.

### BRIEF SUMMARY OF THE INVENTION

An embodiment of a switch is provided. The switch includes a control chip and a trigger device. The trigger device is coupled to a first pin of the control chip. When a user uses the trigger to generate a first control signal, the control chip detects the first control signal via the first pin, and switches the operating mode of the switch to a managed mode from an unmanaged mode according to the first control signal.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a front panel of a network switch according to an embodiment of the invention.

FIG. 2 is a functional block diagram of a network switch according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

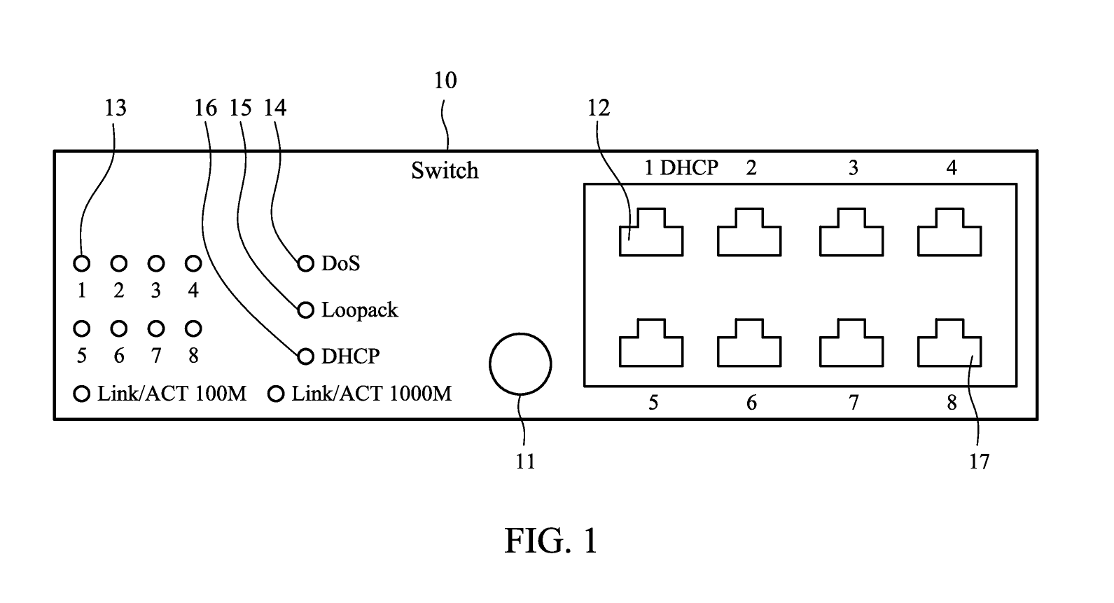

FIG. 1 is a schematic diagram of a front panel of a network switch according to an embodiment of the invention. A trigger device 11, a network connection port 12 and a plurality of LEDs 13-16 are disposed on the front panel 10. The trigger device 11 is coupled to a specific pin of a control chip of a switch. The trigger device 11 may be a button, a switch device, a rotary switch knob, or a touch panel. The user operates the trigger device 11 to generate and transmit a first control signal to the specific pin of the control chip, and the first control signal changes the voltage level of the specific pin. When the control chip detects that the voltage level of the specific pin has changed from a first voltage level to a second voltage level, the control chip switches the operation mode of the network switch from an unmanaged mode to a managed mode. In this embodiment, the default voltage level of the specific pin is logic low and the first control signal is a logic-high signal, wherein the logic low may be a GND level. The logic-high signal may be generated by coupling to a VCC source via a pull-high resistor.

When the network switch operates in the managed mode, the user uses the trigger device to generate a second control signal, i.e. a logic-low signal, to change the voltage level of the specific pin, and the operation mode of the network switch is therefore changed to the unmanaged mode. In this embodiment, the trigger device 11 is a switch device. When the switch device is turned on, the first control signal is generated and transmitted to the control chip; when the switch device is turned off, the second control signal is generated and transmitted to the control chip. In another embodiment, the trigger device is a button. When the user first presses the button, the first control signal is generated and transmitted to the control chip, and when the user presses the button again or releases the button, the second control signal is generated and transmitted to the control chip.

The network connection port 12 can be connected to a computer or a DHCP (Dynamic Host Configuration Protocol) server. In this embodiment, it is recommended that the DHCP server be connected to the network connection port 12 to avoid errors. The LED 13 shows the operation state of the network connection port 12. The LEDs 14-16 present error messages from the network switch, including for such errors as DoS (Denial of Service) attacks, Loopback errors, DHCP errors, and other errors.

When the network switch detects a DoS attack, the LED 14 informs the user by lighting up or blinking. When the network switch detects a loopback error, the LED 15 informs the user by lighting up or blinking. When the network switch detects a DHCP error, the LED 16 informs the user by lighting up or blinking. In other embodiment, LEDs with different colors may be applied to indicate different errors.

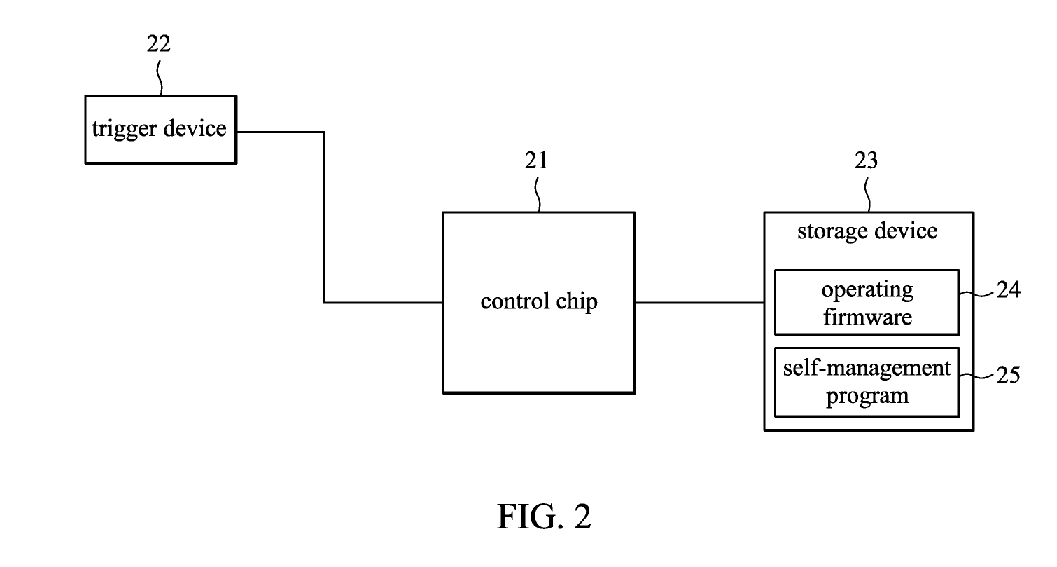

FIG. 2 is a functional block diagram of a network switch according to an embodiment of the invention. The network switch comprises a control chip 21, a trigger device 22, a storage device 23, operating firmware 24 and a self-management program 25. The operating firmware 24 and the self-management program 25 are stored in the storage device 23. The trigger device 22 is disposed on a front panel of the network switch, such as the one shown in FIG. 1. The trigger device 22 is coupled to a pin of the control chip 21 and the voltage level of the pin can be changed by the trigger device 22. The network switch can be switched to a managed switch (operating in a managed mode) or an unmanaged switch (operating in an unmanaged mode) by the trigger device 22.

When the control chip detects that the voltage level of the pin has changed to a second voltage level from a first voltage level, the control chip 21 switches the operating mode of the network switch to the managed mode from the unmanaged mode. In this embodiment, the default voltage level of the pin is logic low and the first control signal is a logic-high signal. When the network operates in the managed mode, the user can use the trigger device 22 to generate a second control signal with a logic-low voltage level and the control chip 21 then switches the network switch to the unmanaged mode from the managed mode.

When the network switch operates in the unmanaged mode, the control chip 21 accesses the storage device 23 to execute the operating firmware 24. When the network switch operates in the managed mode, the control chip 21 accesses the storage device 23 to execute both the operating firmware 24 and the self-management program 25. In other words, the self-management program 25 is executed only when the network switch operates in the managed mode. When the control chip 21 executes the self-management program 25, the control chip 21 monitors the network switch to avoid errors. The network switch has the following functions when operating.

DHCP Prevention Function

Generally speaking, only one DHCP server is allowed in one network. Two or more DHCP servers in the same network may cause errors. Thus, the proposed network switch provides a specific connection port, such as the port labeled DHCP in FIG. 1, for the DHCP server. If the control chip 21 detects that a connection port other than the DHCP port is connecting to an illegal DHCP server, the control chip 21 blocks the connection port.

Loop-Back Detection and Prevention Function

If the user is not familiar with the network switch and incorrectly connects the network switch to another electronic device via network cables, a second loop may occur. When detecting that, the control chip 21 will detect and block the connection port that causes the second loop.

IGMP Snooping V1/V2 Function

The Internet Group Management Protocol (IGMP) is a communications protocol established between IP hosts and adjacent routers on IP networks to maintain multicast group memberships. The control chip 21 differentiates and transmits the multicast messages only to corresponding multicast groups. This reduces bandwidth waste on the part of working stations which do not need the multicast messages. The control chip 21 preferentially transmits the multimedia messages or multimedia packets to corresponding connection ports.

DoS Attack Protection Function

Most of the DoS packets are known, and the control chip 21 first determines whether the received packet is a DoS packet or a multimedia packet. If the received packet is a Dos packet, the received packet is discarded. If the received packet is the multimedia packet, the control chip 21 preferentially transmits the multimedia packet to corresponding connection ports. Furthermore, the proposed network switch can perform as a test apparatus by the functions of error detection and troubleshooting, that is, detecting errors by the LEDs and solving the problems by the trigger device on the network switch. When an error occurs on a connection port, the corresponding LED blinks to inform the user, and the user can use the trigger device to change the operating mode of the network switch to the managed mode. Then, the network switch can self-repair the error and verify the repair result.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A switch, comprising
a control chip comprising a first pin; and
a trigger device coupled to the first pin, wherein when a user uses the trigger device to generate a first control signal and the control chip detects the first control signal via the first pin, the control chip switches an operation mode of the switch from an unmanaged mode to a managed mode according to the first control signal.

2. The switch as claimed in claim 1, wherein when the user uses the trigger device to generate a second control signal, the control chip switches the operation mode of the switch from the managed mode to the unmanaged mode.

3. The switch as claimed in claim 1, wherein a default voltage level of the first pin is logic low, the first control signal is a logic-high signal, and the second control signal is a logic-low signal.

4. The switch as claimed in claim 1, wherein the trigger device is a button or a switch device disposed on a front panel of a housing of the switch.

5. The switch as claimed in claim 1, further comprising a storage device storing operating firmware and a self-management program, wherein the self-management program is executed by the control chip only while in the managed mode.

6. The switch as claimed in claim 5, wherein when the self-management program detects an illegal DHCP server, the self-management program blocks a corresponding port.

7. The switch as claimed in claim 5, wherein when the self-management program detects a second loop, the self-management program determines and blocks a corresponding connection port.

8. The switch as claimed in claim 5, wherein when the self-management program detects a multimedia packet, the self-management program first transmits the multimedia packet to a corresponding port.

9. The switch as claimed in claim 5, wherein the self-management program detects a format of a packet, determines whether the received packet is a DOS packet and if the received packet is determined to be a DOS packet, the received packet is discarded.

10. The switch as claimed in claim 1, further comprising:
a housing, having a front panel on which the trigger device is disposed, wherein an LED is disposed on the front panel to indicate an error status of the switch.
